(19) United States
(12) Patent Application Publication
(10) Pub. No.: US 2008/0281729 A1
(43) Pub. Date: Nov. 13, 2008

(54) Method of Developing, Inventorying and Distributing Content

(76) Inventor: Daniel M. O'BRIEN, Libertyville, IL (US)

Correspondence Address: BEEM PATENT LAW FIRM, 53 W. JACKSON BLVD., SUITE 1352, CHICAGO, IL, 60604-3787, US

(21) Appl. No.: 11/747,144

(22) Filed: May 10, 2007

(51) Int. Cl. G06Q 10/00

(52) U.S. Cl. 705/28

(57) ABSTRACT

A method of developing, inventorying and distributing content with particular applicability to the advertising industry with regard to how agencies may be compensated by advertisers for the development of this content. The method may include the steps of developing a plurality of concepts conceived by at least one creative team working for an agency and inventorying the plurality of concepts in a first computer system. Each one of the plurality of concepts may be saved as a computer file during the inventorying step. The method may further include testing the plurality of concepts to determine at least one winning concept conceived by a winning creative team and a plurality of unselected concepts, distributing the winning concept to an advertiser via electronic transmission to a second computer system, wherein the advertiser is permitted to use the winning concept for a period of time in return for consideration, and sharing rights in at least one unselected concept with the advertiser and the winning creative team. Also included may be a step of allocating a portion of the consideration to the winning creative team.

### BACKGROUND OF THE INVENTION

1. Field of the Invention

The invention is directed to a method for developing, inventorying and distributing content. Specifically, the method may be applied to develop, inventory and distribute advertising services or other creative content, and it may be implemented through the use of at least one computer system.

2. Description of the Related Art

There are several generally accepted models for advertisers to compensate the agencies they employ to develop creative content.

Today, the majority of advertisers &and agencies use a retainer fee model, which is a fixed amount of compensation determined by evaluating the approximate amount of advertising work that needs to be performed in a given period of time, one year, e.g. The advertiser and agency then agree on a specific scope of work for the year and then establish a specific retainer fee the advertiser will pay the agency to perform that work, regardless of the actual number of hours it takes the agency to perform the work, the quantity or quality of the work performed. Included in the hourly rates for these fees are overhead costs and a profit margin.

In a commission model, a fixed percent of the total amount an advertiser spends on media placement is paid to the agency. For example, if an advertiser spends $5 million buying commercial time on TV, the agency will receive $750,000 (15%, e.g.) in compensation.

In a variable labor fees model, an agency may bill an advertiser for the exact hours that agency employees worked for the advertiser. Included in the hourly rates for these fees are overhead costs and a profit margin.

Regardless of the type of model used, the agreement is principally between an advertiser and an agency and does not address compensation for the creative teams that develop the content within the agency. That compensation may be addressed by a work contract that sets an annual salary and a bonus that is discretionally applied. In addition, concepts that are developed by the creative teams in an agency become the property of the advertiser, whether or not the concepts are implemented by the advertisers or considered successful.

Efforts to use systems, such as computer systems, to implement methods for developing, inventorying and distributing content, such as advertising services and other creative content, have not been fully successful, thus, there is a long felt need for a better method.

It would be desirable to create a method that overcomes one or more shortcomings in the prior art.

### BRIEF SUMMARY OF THE INVENTION

A method is provided for developing, inventorying and distributing content that rewards creative teams for their successful concepts, minimizes risk of investment for advertisers and may give agencies and creative teams rights in the work they produce.

In one embodiment, the method may include: developing a plurality of concepts conceived by at least one creative team working for an agency; inventorying the plurality of concepts in a first computer system, wherein each one of the plurality of concepts is saved as a computer file; testing the plurality of concepts to determine at least one winning concept conceived by a winning creative team and a plurality of unselected concepts; distributing at least one winning concept to an advertiser via electronic transmission to a second computer system, wherein advertiser is permitted to use the at least one winning concept for at least a period of time in return for consideration; sharing rights in at least one of the unselected concepts with the advertiser and the winning creative team; and allocating a portion of the consideration to the winning creative team. The portion may be a value corresponding to a percentage of the consideration, or it may be a sum, or some other form of consideration. Method may further include sharing rights in the at least one winning concept with the advertiser and winning creative team. Prior to developing a plurality of concepts, the method provides that agency and advertiser may agree upon a scope of work to perform, for which agency may agree to accept a reduced fee to entice advertiser to use agency's services.

In another embodiment, the method may have the steps of: developing at least one concept to address a business strategy for an advertiser; populating a storage device with the at least one concept; providing advertiser with at least one concept for evaluation; sharing rights in the at least one concept with advertiser and the at least one creative team; and rewarding at least one creative team with consideration if advertiser uses the at least one concept. Moreover, method may include searching storage device for a second concept and selecting the second concept to address a second business strategy.

In a further embodiment, method may include populating a database with a plurality of concepts, wherein an agency and at least one creative team have rights in the plurality of concepts; enabling an entity to search the plurality of concepts in the database and select at least one concept; transferring rights in at least one concept to entity for at least a period of time in exchange for consideration; and allocating a portion of consideration to an at least one creative team that created the at least one concept. Method may additionally include preparing an advertising plan for an advertiser, agreeing with the second agency to receive a second consideration from advertiser if advertiser uses the advertising plan, and adjusting the portion allocated to at least one creative team to account for the second consideration.

### BRIEF DESCRIPTION OF THE DRAWINGS

FIG. 1 is a graphical representation of one embodiment of the inventive method.

FIG. 2 is a schematic of a system that may employ the inventive method.

### DETAILED DESCRIPTION OF THE INVENTION

The following method is used to develop content and rewards the creators of that content for their contributions. While it is recognized that it has applicability to many areas in which creative content is generated, it is described below with respect to the field of advertising. An agency may be any distributor of content, including creative content. In addition, an advertiser may be any recipient of content, including creative content. Content may comprise creative content, concepts, business strategies or media strategies and planning and the description of method 10 with regard to one form of content does not preclude its applicability to other forms.

Advertising agencies may deal with advertisers in several ways. For example, an agency, subject to a nondisclosure agreement, may have to make an initial business pitch to an advertiser in order to have the advertiser become a client. In method 10 of the current invention, advertiser may share its business strategy with agency so that at least one creative team within agency may create at least one concept to propose. In the context of advertising, a creative team generally comprises an art director and a copywriter. However, a creative team may comprise a single individual, several individuals, or some other entity that conceives content. Agency presents the at least one concept to advertiser, who may choose to either hire agency or not. Method 10 provides that, if advertiser likes at least one of the at least one concepts and hires agency, advertiser may share the rights in the at least one concept with agency and the at least one creative team that developed the favorable concept or concepts. In one variation, sharing of rights may be accomplished through the use of a license or royalty. Conversely, if advertiser decides to not hire agency, agency may retain the rights to the at least one concept that was created, or, for each concept, it may share those rights with the at least one creative team that developed the concept. However, agency may also agree to share rights in the at least one concept with advertiser, or it may agree to transfer all of the rights to advertiser.

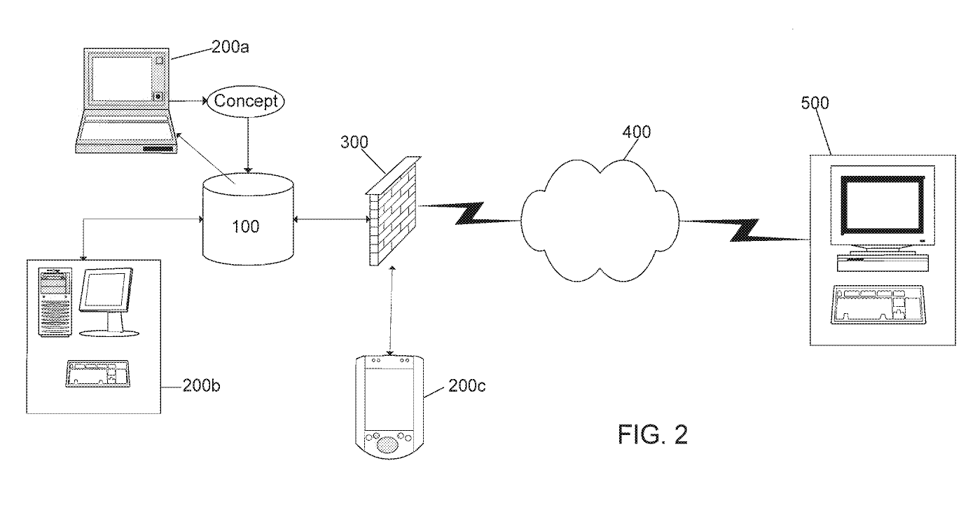

As shown in FIG. 2, for those concepts in which agency retains rights, concepts may be used to populate a library or database 100. Database may be any collection of data, concepts or other content and may be used interchangeably with an electronic folder or electronic library. Concepts may be represented physically and, therefore, be catalogued in a physical library. Concepts may also be stored digitally in a database 1100 that is searchable by at least one computer 200 that may be a laptop computer 200a, a desktop computer 200b, a hand held computer 200c, a mobile telephone or either type of computer that is capable of interfacing with database 100.

In another embodiment, advertiser may already be a client of agency. Agency may be subject to a nondisclosure agreement that prevents it from disclosing advertiser's proprietary business strategy. However, advertiser may also seek agency's expertise in defining, refining, or otherwise improving its business strategy. Regardless, method 10 provides that agency will agree with advertiser on a scope of work for agency to perform. In the context of advertising, scope of work may correspond to the number of internet solutions, magazine advertisements, radio advertisements, television commercials, etc. that advertiser wants prepared. Scope of work may also comprise media strategy, planning, buying and measurement, and online and offline integration strategy. Additionally, scope of work may be used to define the number of hours or extent of work that is required to prepare concepts for advertiser.

At this stage, agency may set a rate or a reduced rate for fees that it will require to create or refine at least one concept, preferably a plurality of concepts. Reduced rate may be based on one of several formats well-known in the art. Preferably, rates may be set according to a cost-plus format where agency charges for the time spent developing the at least one concept, plus, for example, a small percentage of that cost that allows agency to improve the at least one concept. Alternatively, agency may charge according to a cost format that accounts for only the time spent developing the at least one concept. In these formats, agency receives generally no profit for the work its creative teams perform in preparing the at least one concept. However, other methods may be used to calculate this reduced rate, including those that incorporate a profit.

Reduced rate may be favorable to advertiser because, by generally not having to pay a profit factor at this stage, there is less investment involved, which translates into less risk if advertiser is not satisfied with the concepts that are conceived. In addition, agency may be willing to risk generally incurring no profit at this stage because of the possibility of receiving consideration, in the form of royalties, for example, at a later stage (discussed below).

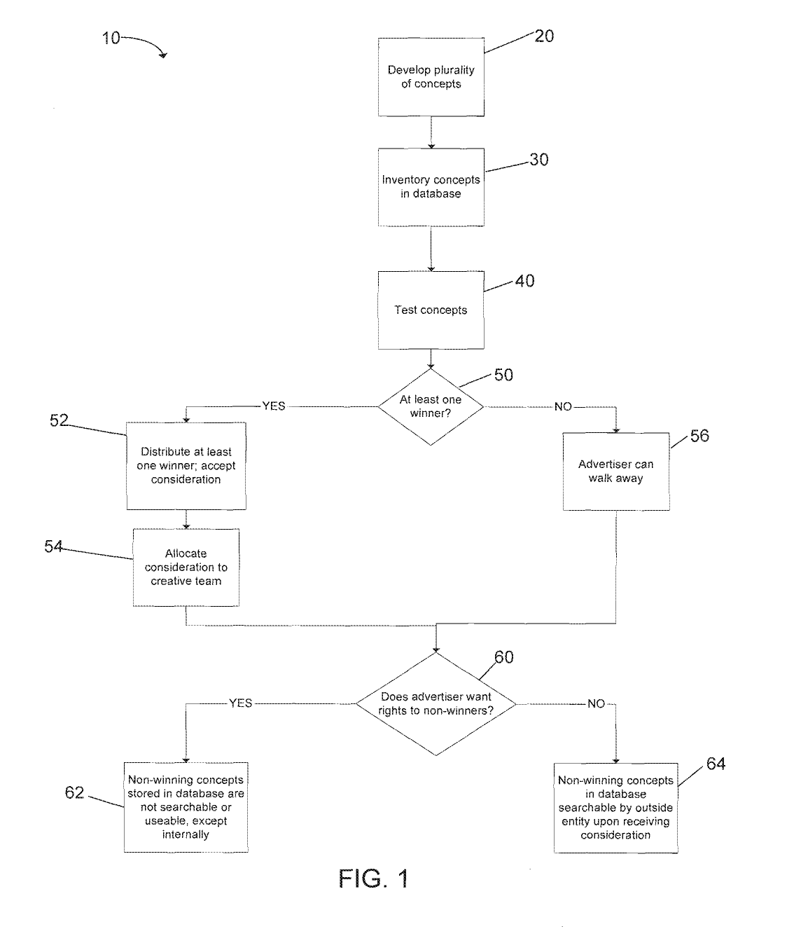

Once a scope of work has been agreed upon, at least one creative team within agency may develop a plurality of concepts for advertiser, as shown in developing step 20 in FIG. 1. Plurality of concepts may be stored or inventoried in database 100 during inventorying step 30 in order to collate them in a single general location, make them more easily searchable and make them more easily modifiable. As shown in FIG. 2, database 100 is preferably a centralized database that is accessible by each of the at least one creative teams so that each team may be able to contribute concepts or other content to the database 100, as well as draw upon the collective information stored in database 100 for creative inspiration, e.g. Database 100 may be partitioned so as to form a working directory of certain creative concepts that may be retrieved, edited and replaced with modified versions, as well as a section of stored concepts that may be retrieved and replaced but not generally edited. Although database 100 may be accessible by entities within agency, agency may wish to protect database 1100 from unauthorized access. Database 100 may be encrypted or password protected, or, as seen in FIG. 2, may be separated from outside access via firewall 300.

Once the at least one creative team has produced a plurality of concepts in developing step 20, market research, selection by the advertiser, or other forms of testing may be employed to preferably determine at least one winning concept during testing step 40. At the end of testing step 40, it may be determined if any of the plurality of concepts is a winning concept at winning choice 50. At the end of concept development and testing, advertiser may decide to terminate its relationship with agency at step 56. In this case, advertiser will only be responsible for paying the reduced rate agreed upon earlier.

If advertiser is satisfied with the at least one winning concept, method 10 provides for advertiser and agency to enter into an agreement that allows advertiser to use the at least one winning concept for at least a period of time in exchange for agency receiving consideration. Agreement may take the form of a license agreement, for example. In one version of a license agreement, agency may charge a flat rate for a first cycle that allows advertiser to test the success of the at least one winning concept. In comparison, agency may vary the number of cycles or rate of interest of license agreement. In the case of a multiple-cycle license, advertiser may be permitted to abandon the agreement between cycles. However, it may be required to pay a penalty for doing so and may not be permitted to use the at least one winning concept in the future unless it enters into a new agreement with agency. In either case, advertiser may obtain rights in the at least one winning concept, such as the right to use, but agency may also retain rights in the at least one winning concept.

At or around this stage of method 10, the at least one winning concept is distributed to advertiser at distributing step 52, preferably using a computer system 200. Computer system 200 may be the same system that was used to add concepts to database 100 during the inventorying step, but it may be a different system. Transmittal may occur via Internet transmission 400 to a recipient's computer system 500, but may also occur via a network connection, intranet or by copying files containing the at least one winning concept to a portable media storage device, such as a CD-ROM disc or a portable memory stick or other flash memory device and uploading data files to recipient's computer system 500. Once the at least one winning concept has been distributed to advertiser, it may be implemented as an internet solution, magazine advertisement, radio advertisement, television commercial, media strategy, planning, or buying and measurement plan, or online or offline integration strategy, as well as any other implementation commonly known in the art.

Moreover, method 100 provides that the at least one creative team that conceived the at least one winning concept may also retain rights in the at least one winning concept. At the end of the agreement, agency may negotiate a new agreement with advertiser, extending its duration enlarging or otherwise changing its scope, for example. If either party does not want to renew the agreement, method 10 provides that rights in the at least one winning concept may revert from the advertiser back to the agency and/or the at least one creative team. Conversely, advertiser may seek a one-time buyout, i.e. to obtain generally all of the rights in the at least one winning concept at the inception of the agreement, for which agency may adjust the amount it charges advertiser.

An important point of method 10 is that, regardless of the form the agreement between advertiser and agency takes, in addition to agency receiving consideration from advertiser for its at least one winning concept, the at least one creative team that developed the at least one winning concept will be compensated for its success. Method 10 provides that a portion of the consideration, or a value associated with that portion, will be allocated to the at least one creative team. Consideration may be determined by a value corresponding to a percentage of the consideration received by agency. Alternatively, the at least one creative team may receive a sum payment for having its winning concept be selected. Allocation may be made in a lump sum fashion generally when agreement between agency and advertiser is finalized, or it may be distributed periodically, for example, over the life of a license agreement. Other means of providing consideration may be contemplated but are within the scope of method 10. Preferably, consideration for conceiving a winning concept is in addition to consideration otherwise already provided to creative team by agency. However, it may be possible for agency to only provide consideration for winning concepts.

A goal of method 10 is to attract and retain highly-skilled, exceptional talent to serve in an agency's creative department by introducing a unique and extraordinary method of compensation. However, method 10 may provide several alternatives to manage a creative team, or a member of a creative team, leaving the agency. For illustrative purposes, discussion will be made with reference to a single member of a creative team leaving. However, similar results may be obtained if an entire team leaves, as well.

In a preferred embodiment, method 10 provides that leaving agency results in forfeiting any remaining consideration due to member, as well as transfer of rights in any concepts developed by member to agency. In this way, method 10 provides an incentive for member to remain with agency; member benefits from the continued consideration and agency benefits from member's creative contributions. In another embodiment, method 10 may provide that member may still receive consideration for winning concepts it helped conceive. It may also provide that member retains rights in concepts it developed. However, agency may obtain these rights as well. Moreover, member may be permitted to receive a portion of the consideration due had it remained at agency, but may forfeit a remainder, as well as a portion, or all, of the rights it has in concepts it develops. As with the consideration structure, other forms of managing the departure of a member or creative team may be contemplated and are within the scope of method 10.

As discussed above, the at least one creative team may develop a plurality of concepts. However, fewer than all of them may be chosen as winning concepts. In one variation, agency may retain rights in the non-winning concepts, to the exclusion of advertiser. In addition, the at least one creative team that developed a non-winning concept may also have rights in that concept. However, method 10 also contemplates that advertiser may wish to have rights in at least one of the non-winning concepts at choice 60. This may be particularly true depending on how closely the concept portrays the advertiser's proprietary business strategy.

If advertiser desires to retain rights in at least one of the non-winning concepts, agency may require consideration from advertiser in exchange for those rights. However, agency may also agree to forego consideration and provide rights in those non-winning concepts to advertiser. Agency may do so to create good-will between advertiser and agency or for other reasons.

Method 10 recognizes that there may still be value attached to non-winning concepts. For each job that an agency undertakes, a plurality of non-winning concepts may be created. According to method 10, a library or database of concepts may be created at storage step 64. In some cases, concepts are displayed in a physical form; a storyboard, a model, etc. However, for illustrative purposes, creative concepts will be considered a plurality of digital objects that may be saved as data files, used to populate a storage device, and may be accessible using at least one computer system. Storage device may be a database or other form of electronic storage library and may be referred to below as a database for illustrative purposes. In addition, database may be accessible over the Internet via a secure connection such as a password or encryption system. Storage device may be protected by at least one firewall to prevent unauthorized access of content. Over time, agency may develop a broad portfolio of great potential value if they become relevant and licensed to different advertisers in many businesses, industries or consumer segments.

When a concept is saved to storage device, it may be saved with information detailing what creative team conceived it. Concepts that may have been pitched to an advertiser when agency was trying to make advertiser a client, non-winning concepts for which advertiser has not obtained all of the rights, winning concepts for which an agreement between advertiser and agency may have lapsed, as well as “brainstorming” concepts that may or may not be related to a project on which a creative team is working may comprise entries in the storage device. As discussed above, advertisers may wish to obtain the rights to some non-winning concepts, for example, to prevent competitors from learning about, copying, or possibly using these concepts or their general business strategy. Method 10 (provides that those concepts for which advertiser obtains partial or all rights may not be entered into storage device.

Storage device may be searchable and may, therefore, provide a valuable source of additional concepts for creative teams and agency in future jobs. Concepts that may have been non-winning concepts for one advertiser may become winning concepts for another advertiser, or other creative teams within agency may draw inspiration from these concepts to create new, winning concepts.

Because the database entries may contain information regarding the creative team that created the related concepts, if a concept in the database becomes a winning concept, it may be possible to provide consideration to its respective creators. This provides an incentive to the creative teams to not only conceive of concepts, even if unrelated to a project on which they may be working, but to record and report those concepts to the agency. In addition, the same possibilities regarding potential forfeiture of consideration or rights in concepts that are discussed above with regards to winning concepts and members of creative teams leaving the agency may apply to concepts stored in the database.

Method 10 contemplates that other entities may be entitled to search the database of concepts. In one variation, advertiser may not have a business strategy, or it may not have a fully-developed strategy, for example. In that case, agency may allow advertiser to search database for general strategies to focus its plan, or to search concepts within certain strategies for those it may want agency to develop further. One advantage of this system may be allowing agency to have a “head start” in developing its concepts since it may already know, generally, what advertiser wants, allowing it to provide advertiser with better concepts. Moreover, it may appeal to an advertiser that is not yet a client of agency and may result in advertiser becoming a client based on the help concepts in the database may provide. In order to protect its rights in the database, however, agency may provide that anyone to whom it grants access recognizes that it does not obtain any rights in the concepts it views or selects or it may prevent them from seeing certain entries, as shown in selective step 62).

In addition, also as part of selective step 62, agency may make database accessible to another outside entity, such as another agency. Other entity may be required to pay a fee or provide other valuable consideration to agency for the right to search database and, upon finding at least one concept it wishes to develop for an advertiser, may be required to provide further consideration to the agency for the right to use the at least one concept. Conversely, other entity may be allowed to use the concept, but may be required to forego some of the consideration it receives from advertiser by allowing agency to form an agreement with advertiser to receive consideration directly from advertiser. In either case, method 10 envisions that the creative team responsible for the selected concept would receive consideration for its concept being used.

Method 10 recognizes that there is value in attracting and retaining talent to serve in an agency's creative department. It provides incentives to the team to create concepts in addition to those related to jobs on which it is already working. In addition, by providing consideration to the team for winning concepts it designs and refines, it provides incentives to remain at an agency. By doing so, agency may benefit by attracting the highest-quality talent that produces better or more successful content than what other agencies may produce, or what the agency may be able to produce without the incentives. This may make them more appealing to advertisers that seek successful concepts. In addition, it may make agencies more attractive to advertisers looking to develop special, distinctive brand concepts that may last for a long time and have a high value. While advertisers may have to relinquish some of the rights in the creative content to the agency and/or the creative teams, method 10 reduces the risk associated with having an agency prep are a plurality of concepts for review by setting a reduced rate for fees to create the plurality of concepts that may not include a profit margin for the agency. In addition, method 10 may minimize the risk bay permitting an advertiser to not use any of the proposed concepts and not owe the agency anything other than the reduced rate that was earlier set.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A method of developing, inventorying and distributing content, comprising:
developing a plurality of concepts conceived by at least one creative team working for an agency;
inventorying said plurality of concepts in a first computer system, wherein each one of said plurality of concepts is saved as a computer file;
testing said plurality of concepts to determine at least one winning concept conceived by a winning creative team and a plurality of unselected concepts;
distributing said at least one winning concept to an advertiser via electronic transmission to a second computer system, wherein said advertiser is permitted to use said at least one winning concept for at least a period of time in return for consideration;
sharing rights in at least one of said unselected concepts with said advertiser and said winning creative team; and
allocating a portion of said consideration to said winning creative team.

2. A method according to claim 1, wherein said first computer system comprises a database that may be interfaced using at least one computer.

3. A method according to claim 1, further comprising
agreeing upon a fee schedule and scope of work for developing said plurality of concepts, prior to developing said plurality of concepts.

4. A method according to claim 3, wherein said fee schedule comprises a rate that includes a marginal profit.

5. A method according to claim 1, wherein said portion is a value corresponding to a percentage of said consideration.

6. A method according to claim 1, wherein said portion is a sum.

7. A method according to claim 1, wherein said distributing step further comprises sharing rights In said at least one winning concept with said advertiser and said winning creative team.

8. A method according to claim 1, wherein said distributing step further comprises transferring rights in said at least one winning concept to said advertiser.

9. A method according to claim 1, wherein said distributing step further comprises enabling advertiser to gain additional rights in at least one non-winning concept.

10. A method according to claim 1, further comprising:
acquiring rights in concepts conceived by a creative team if said creative team no longer works for said agency.

11. A method according to claim 1, further comprising:
repeating said distributing and allocating steps for an at least second period of time at the end of said first period of time for a second consideration.

12. A method according to claim 1, further comprising:
populating a database with content conceived by at least one second creative team.

13. A method according to claim 12, wherein said database is further populated with at least one non-winning concept.

14. A method according to claim 12, wherein said compiling step comprises:
searching said database for at least one second concept.

15. A method according to claim 14, wherein said compiling step further comprises:
revising said at least one second concept to address needs of an advertiser.

16. A method of developing, inventorying and distributing content, comprising:
developing at least one concept to address a business strategy for an advertiser:
populating a storage device with said at least one concept;
providing said advertiser with said at least one concept for evaluation;
sharing rights in said at least one concept with said advertiser and said at least one creative team; and
rewarding said at least one creative team with consideration if said advertiser uses said at least one concept.

17. A method according to claim 16, further comprising:
searching said storage device for a second concept; and
selecting said second concept to address a second business strategy.

18. A method of developing, inventorying and distributing content, comprising:
populating a database with a plurality of concepts, wherein an agency and at least one creative team have rights in said plurality of concepts;
enabling an entity to search said plurality of concepts in said database and select at least one concept of said plurality of concepts;
transferring rights in said at least one concept to said entity for at least a period of time in exchange for consideration;
allocating a portion of said consideration to an at least one creative team that created said at least one concept.

19. A method according to claim 18, wherein said entity is a second agency that is preparing an advertising plan for an advertiser and further comprising:
agreeing with said second agency to receive a second consideration from said advertiser if said advertiser uses said advertising plan;
adjusting said portion allocated to said at least one creative team to account for said second consideration.
